(19) United States
(12) Patent Application Publication
(10) Pub. No.: US 2005/0144379 A1
(43) Pub. Date: Jun. 30, 2005

(54) Ordering disk cache requests

(76) Inventor: Michael K. Eschmann, Lees Summit, MO (US)

Correspondence Address: TROP PRUNER & HU, PC, 8554 KATY FREEWAY, SUITE 100, HOUSTON, TX, 77024, US

(21) Appl. No.: 10/751,018

(22) Filed: Dec. 31, 2003

(51) Int. Cl. G06F 12/00

(52) U.S. Cl. 711/113; 711/158

(57) ABSTRACT

Non-demand requests may be queued and delayed until pending demand requests to a cached disk subsystem have been completed. This may improve system responsiveness in some embodiments of the present invention. If, during an idle time, when a write back request is being handled, a new demand request is received, in some embodiments, the new demand request may be taken up, and the write back request stalled for later execution after the demand request. By providing a higher priority to a demand request to the cached disk subsystem, input/output requests may be satisfied more quickly, improving user responsiveness in some embodiments.

### BACKGROUND

This invention relates generally to using disk caches in processor-based systems.

Peripheral devices such as disk drives used in processor-based systems may be slower than other circuitry in those systems. The central processing units and the memory devices in systems are typically much faster than disk drives. Therefore, there have been many attempts to increase the performance of disk drives. However, because disk drives are electromechanical in nature there may be a finite limit beyond which performance cannot be increased.

One way to reduce the information bottleneck at the peripheral device, such as a disk drive, is to use a cache. A cache is a memory location that logically resides between a device, such as a disk drive, and the remainder of the processor-based system, which could include one or more central processing units and/or computer buses. Frequently accessed data resides in the cache after an initial access. Subsequent accesses to the same data may be made to the cache instead of the disk drive, reducing the access time since the cache memory is much faster than the disk drive. The cache for a disk drive may reside in the computer main memory or may reside in a separate device coupled to the system bus, as another example.

Disk drive data that is used frequently can be inserted into the cache to improve performance. Data which resides in the disk cache that is used infrequently can be evicted from the cache. Insertion and eviction policies for cache management can affect the performance of the cache. Performance can also be improved by allowing multiple requests to the cache to be serviced in parallel to take full advantage of multiple devices.

In some cases, information may be taken and stored in the disk cache without immediately updating the information in the disk drive. In a write back policy, information may be periodically written back from the disk cache to the disk drive.

For a variety of reasons, an operating system may request a driver to flush the disk cache at any time. There are times when correct data resides on the cache but not on the disk drive and that data needs to be written back to the disk drive either upon a flush request or upon request from a driver to keep the cache clean. Unfortunately, in some cases, these flushes can take a long time and significantly delay processing of incoming demand requests. These delays may result in poor system performance.

Thus, there is a need for alternate ways of writing back data from disk caches to disk drives.

### BRIEF DESCRIPTION OF THE DRAWINGS

FIG. 1 is a schematic depiction of one embodiment of the present invention;

FIG. 2 is data flow diagram for one embodiment of the present invention; and

FIG. 3 is a flow chart for software in accordance with one embodiment of the present invention.

### DETAILED DESCRIPTION

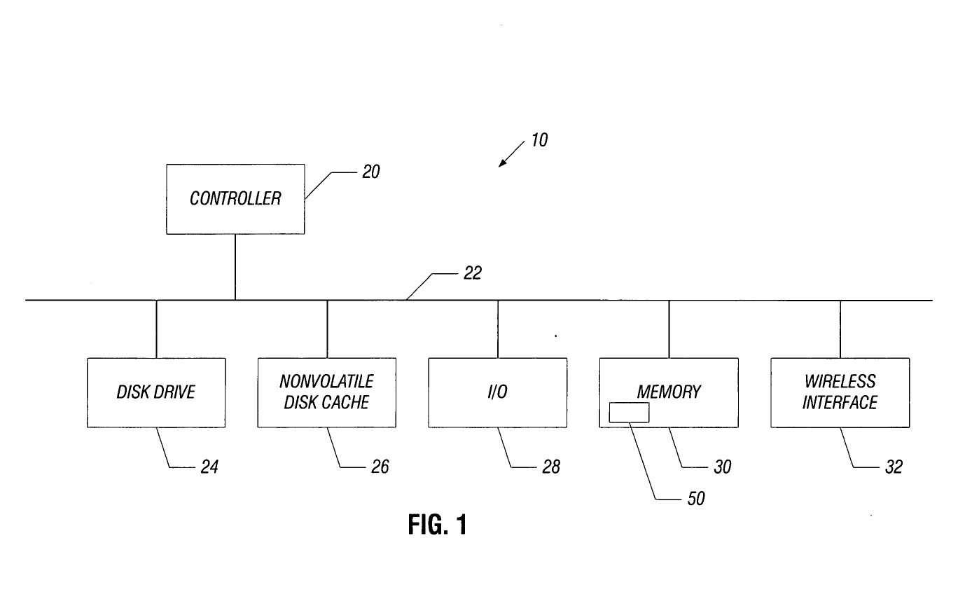

Referring to FIG. 1, a portion of a system 10, in accordance with one embodiment of the present invention, is illustrated. The system 10 may be used in a wireless device such as, for example, a laptop or portable computer with wireless capability, a web tablet, a digital music player, a digital camera, or a desktop computer, to mention a few examples. The system 10 may be used in wireless applications as one example. More particularly, the system 10 may be utilized as a wireless local area network system, a wireless personal area network system, or a cellular network, although the scope of the present invention is in no way limited to wireless applications.

The system 10 may include a controller 20, an input/output (I/O) device 28 (e.g., a keypad, a display), a memory 30, and a wireless interface 32 coupled to each other via a bus 22. It should be noted that the scope of the present invention is not limited to embodiments having any or all of these components.

Also coupled by the bus 22 is a disk cache 26 and a disk drive 24. The disk cache 26 may be any type of non-volatile memory including a static random access memory, an electrically erasable programmable read only memory, a flash memory, a polymer memory such as ferroelectric polymer memory, or an ovonic memory, to mention a few examples. The disk drive 24 may be a magnetic or optical disk drive. The controller 20 may comprise, for example, one or more microprocessors, digital signal processors, microcontrollers, to mention a few examples.

The memory 30 may be used to store messages to be transmitted to or by the system 10. The memory 30 may also be used to store instructions that are executed by the controller 20 during the operation of the system 10, and may be used to store user data. The memory 30 may be provided by one or more different types of memory. For example, the memory 30 may comprise a non-volatile memory. The cache 26, disk drive 24, and driver 50, stored on memory 30, may constitute a cached disk subsystem.

The I/O device 28 may be used to generate a message. The system 10 may use the wireless interface 32 to transmit and receive messages to and from a wireless communication network with a radio frequency signal. Examples of these wireless interface 32 may include a wireless transceiver or an antenna, such as a dipole antenna, although the scope of the present invention is not limited in this respect.

With a conventional system, requests to the cached disk subsystem, including the cache 26, are executed in the order received. Thus, if a demand request (that is, a request to write data to or read data from the cached disk subsystem) is received and then a flush request is received, the requests are handled in that order. This may be inefficient when two demand requests are followed by a flush request, in turn followed by still another demand request. This is because the third demand request gets delayed by the write back execution.

Thus, some existing methods prevent demand request execution while dirty cache lines are being written back until the entire cache is made clean. This may happen during many operating system events, such as system shutdown, cache flush demand, and even when the cache needs to be cleaned during normal data transfers. This delaying method of flushing cache causes operating system reaction to demand requests to incur significant latency, which also increases response time for the user. This user response time increase may cause applications to appear to take longer to respond during run time or shutdown.

In accordance with some embodiments of the present invention, write backs of data from the cache 26 to the drive 24 and flushing of the data in the cache 26 may be scheduled, or prioritized, to reduce the disruption of demand requests. Instead, the flushing may be deferred until idle times. These idle times may be times when demand requests are not pending or, for any other reason, it is opportune in terms of system performance to perform the flush and write back. Basically, the write back requests may be assigned a lower priority than demand data requests to reduce stalling of incoming demand requests. The write back operation may be made flexible enough to allow tailored response to both requested and opportunistic flushes. When the cache subsystem is determined to be idle or when the driver receives commands for run-time flush requests, power events such as system shutdown and run-time data requests may be recognized as opportunities for write backs.

Initially, request packets may be queued like any demand request and executed in a way to reduce the delay in handling incoming demand requests. In other words, new demand requests may be executed prior to cleaning the entire cache 26. This priority system allows the caching driver to streamline requests to the appropriate device without constantly re-synchronizing demand request execution queues. The caching driver can streamline demand requests during the write back flush by treating write backs as a lower priority relative to demand requests.

For example, in a cached disk subsystem, a first demand request may be received, followed by a second demand request, in short order. Thereafter, a shutdown or flush request may be received in short order. After a first idle time, a third demand request may be received and thereafter, after a second idle time, still additional demand requests may be received. The first and second demand requests may be executed and then some of the write back requests may be executed in the first idle time until such time as the third demand request is received, followed by a third idle time. After receipt of the third demand request, the cached disk subsystem may halt the write back requests, execute the third demand request, and then go back to executing more write back requests during the third time. When another demand request is received, the subsystem may return to handling that demand request, again delaying the write back requests until the next idle time.

In accordance with some embodiments of the present invention, the driver 50 breaks up the write backs to the disk drive 24 into multiple small disk input/outputs that may be preempted by incoming demand requests. Thus, write backs and flushes may occur during idle times. When a demand request comes in, the write back requests may be stalled or delayed until after the write back request is handled. Incoming demand requests may take priority to write back requests, improving demand latency and improving user response time in some embodiments. Flushes may occur at shutdown and at other times prior to shutdown.

In one embodiment of the present invention, if a write request to the cache 26 is not received within a certain amount of time, queued write backs and flushes begin to be executed. An atomic unit of write backs and flushes may be accomplished before interrupting to take on a newly received demand request in some embodiments of the present invention.

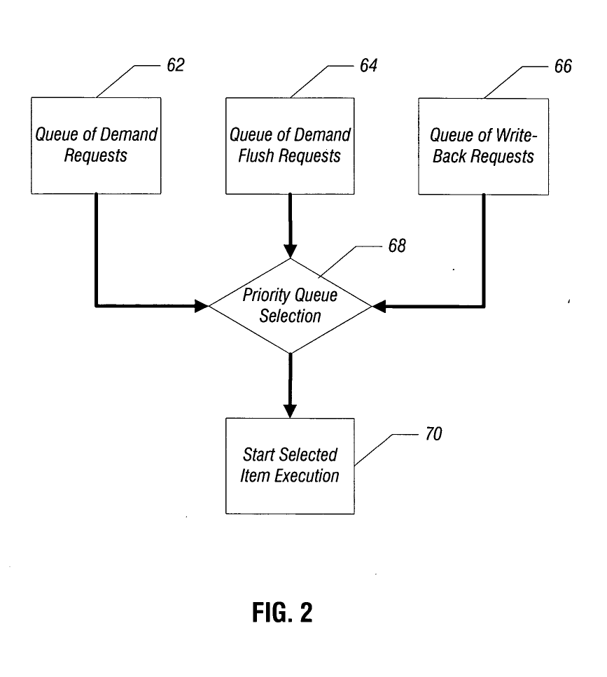

Referring to FIG. 2, the write back driver 50 begins by queuing incoming demand requests, flush requests, and write back requests, as indicated in blocks 62, 64, and 66 in one embodiment of the present invention. A queued request is selected as indicated in diamond 68 for execution, starting with any queued demand requests. The selected request is then executed, as indicated in block 70.

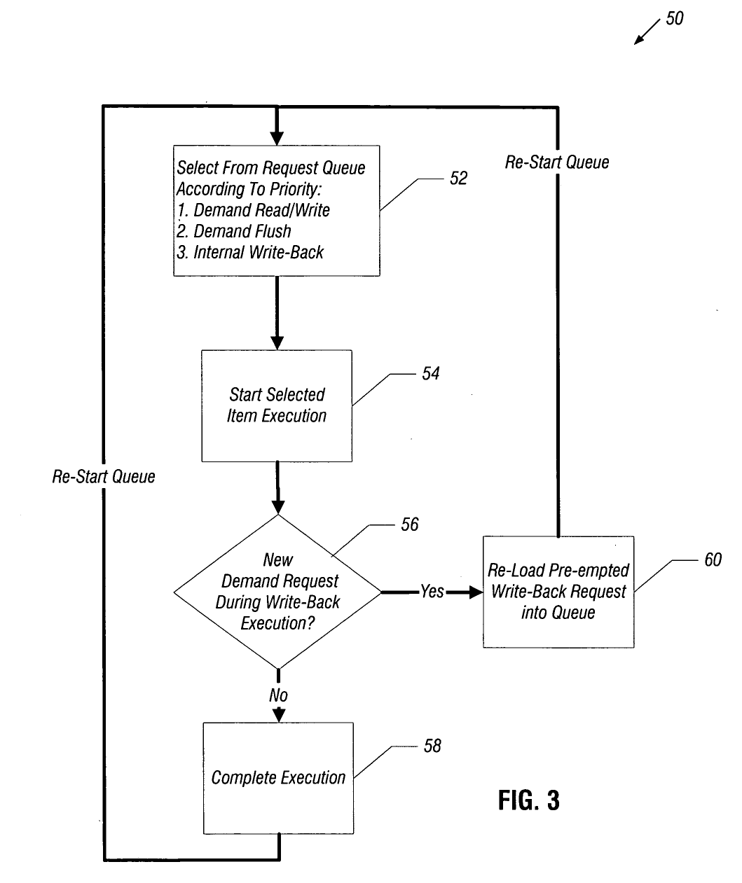

Referring to FIG. 3, the driver 50 selects a request for execution according to a priority system that gives the highest priority to demand requests to read to or write from the cached disk subsystem, the next lower priority to demand flush requests, and the lowest priority to internal write backs from the cache to the disk, all as indicated in block 52. Execution begins as indicated in block 54. If a new demand request is received during execution of a non-demand request (e.g., a write back request or a demand flush) as determined in diamond 56, the write back request is preempted and reloaded into the queue as indicated in block 60. If no such demand request is received during execution, execution of the lower priority flush or write back request is completed as indicated in block 58.

In some embodiments of the present invention, incoming demand requests take priority over write back requests. This prioritization may reduce the time to satisfy demand input/output requests and may improve user responsiveness in some embodiments. The prioritization of demand requests may occur when cache flush events are occurring on behalf of the driver opportunistically flushing or when the cache flush events are happening during normal demand requests, operating system shutdown and flush, or at various power management state changes. Improved response time allows applications to respond quicker during these events and to keep cache write backs truly in the background.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
determining if there is a pending demand request to a cached disk subsystem and, if not, executing a non-demand request.

2. The method of claim 1 including queuing requests including demand requests, requests to write from the cache back to a disk drive, and requests to flush the cache.

3. The method of claim 2 wherein if the next request is a non-demand request, executing said non-demand request and monitoring for a demand request.

4. The method of claim 3 including preempting the execution of the non-demand request after receiving a demand request and executing the demand request before completing the non-demand request.

5. The method of claim 4 including re-queuing said non-demand request for execution after the completion of the demand request.

6. The method of claim 1 including determining whether the cache is idle before executing a write back request.

7. The method of claim 1 including interrupting a write back request during its execution after receiving a demand request.

8. The method of claim 1 including executing cache flush operations when a pending write back request has been received.

9. The method of claim 1 including executing a driver generated non-demand write back request.

10. An article comprising a medium storing instructions that, if executed, enable a processor-based system to:
determine if there is a pending demand request to a cached disk subsystem and, if not, execute a non-demand request.

11. The article of claim 10 further storing instructions that, if executed, enable the processor-based system to queue requests including demand requests, requests to write from the cache back to a disk drive, and requests to flush the cache.

12. The article of claim 11 further storing instructions that, if executed, enable the processor-based system to execute said non-demand request and monitor for a demand request.

13. The article of claim 12 further storing instructions that, if executed, enable the processor-based system to interrupt the execution of the non-demand request after receiving a demand request and execute the demand request before completing the non-demand request.

14. The article of claim 13 further storing instructions that, if executed, enable the processor-based system to re-queue said non-demand request for execution after the completion of the demand request.

15. The article of claim 10 further storing instructions that, if executed, enable the processor-based system to determine whether the cached disk subsystem is idle before executing a non-demand request.

16. The article of claim 10 further storing instructions that, if executed, enable the processor-based system to interrupt the execution of a non-demand request after receiving a demand request.

17. The article of claim 10 further storing instructions that, if executed, enable the processor-based system to execute cache flush instructions when a pending write back request has been received.

18. A system comprising:
a cache;
a disk drive coupled to said cache; and
a controller to determine if there is a pending demand request to a cached disk subsystem and, if not, implement a non-demand request.

19. The system of claim 18, said controller to queue requests including demand requests, requests to write from the cache back to the disk drive, and requests to flush the cache.

20. The system of claim 19, said controller to execute a non-demand request and monitor for a demand request.

21. The system of claim 20, said controller to interrupt the execution of a non-demand request after receiving a demand request and execute the demand request before completing the non-demand request.

22. The system of claim 21, said controller to re-queue said non-demand request after a completion of the demand request.

23. The system of claim 18, said controller to determine whether the cached disk subsystem is idle before executing a non-demand request.

24. The system of claim 18, said controller to interrupt the execution of a non-demand request after receiving a demand request.

25. The system of claim 18, said controller to execute cache flush instructions when a pending write back request has been received.
